(19) United States
(12) Patent Application Publication
(10) Pub. No.: US 2017/0005555 A1
(43) Pub. Date: Jan. 5, 2017

(54) ASYMMETRIC SALIENT PERMANENT MAGNET SYNCHRONOUS MACHINE

(71) Applicant: Purdue Research Foundation, West Lafayette, IN (US)

(72) Inventors: Jamal Y. Alsawalhi, West Lafayette, IN (US); Scott D. Sudhoff, West Lafayette, IN (US)

(73) Assignee: Purdue Research Foundation, West Lafayette, IN (US)

(21) Appl. No.: 15/200,305

(22) Filed: Jul. 1, 2016

Related U.S. Application Data
(60) Provisional application No. 62/188,237, filed on Jul. 2, 2015.

(51) Int. Cl. H02K 21/14; H02K 3/18; H02K 1/14; H02K 1/27; H02K 1/02; H02K 1/24

(52) U.S. Cl. CPC H02K 21/14; H02K 1/02; H02K 1/24; H02K 1/146; H02K 1/2706; H02K 3/18

(57) ABSTRACT

A permanent magnet machine is disclosed, including a stator assembly which includes a housing, a stator backiron, a plurality of windings disposed in the housing coupled to a plurality of electrical connections, and a plurality of stator teeth coupled to the stator backiron. The permanent magnet also includes a rotor assembly which includes a center configured to couple to a mechanical coupling member disposed about the center, an inner core, positioned around the center, an outer core disposed around the inner core, and a plurality of outwardly protruding poles radially located within the stator assembly each outwardly protruding pole having an outer surface adjacent to at least one tooth of the plurality of teeth. Each outer surface of each outwardly protruding pole having a rotor tooth extending from the outer core and a permanent magnet disposed next to the rotor tooth.

### CROSS REFERENCE TO RELATED APPLICATIONS

The present application is related to and claims the priority benefit of U.S. Provisional Patent Application Ser. No. 62/188,237 filed Jul. 2, 2015, the content of which is hereby incorporated by reference in its entirety into the present disclosure.

### STATEMENT REGARDING GOVERNMENT FUNDING

This invention was made with government support under NNX12AM04G awarded by National Aeronautics and Space Administration and Contract No. DE-EE0005568 awarded by the U.S. Department of Energy to the Hoosier Heavy Center of Excellence Fellowship. The government has certain rights in the invention.

### TECHNICAL FIELD

The present disclosure generally relates to electric machines and particularly to permanent magnet machines providing high torque density.

### BACKGROUND

This section introduces aspects that may help facilitate a better understanding of the disclosure. Accordingly, these statements are to be read in this light and are not to be understood as admissions about what is or is not prior art.

Currently, there is great social interest in increasing the efficiency of power magnetic devices such as electric generators and motors, which are used in applications such as wind energy turbines and hybrid and/or electric vehicles. For example, there has been an ongoing desire to improve conventional permanent magnet synchronous machines (PMSMs). PMSMs have historically been present in specialty applications of small ratings or in very high speed applications, for example, in excess of 20,000 rpm. Examples include spindle drives and flywheel energy storage machines. Advancements in the late 20th century in high energy permanent magnets increased interest in PMSMs. For example, utilization of PMSMs in full and hybrid electric vehicles has drastically increased in the last several years, where it is believed to have accounted for sixty-five percent of electric machines topologies used. Reasons for this increase are believed to be related to the drawbacks that other machine topologies suffer from. Direct Current (DC) machines, although capable of providing high stall torque, suffer from degradation of carbon brushes, which creates an ongoing maintenance issue. Induction machines exhibit the advantage of low cost and high robustness but need sophisticated control to accommodate wide speed operation. Reluctance machines suffer from low efficiency and relatively low power density. PMSMs on the other hand are typically known for their high torque density for a given loss, high reliability, and high system efficiency.

PMSMs can in general be classified as Surface Mounted Permanent Magnet Synchronous Machines (SM-PMSMs), or Interior Permanent Magnet Synchronous Machines (IPMSMs), with a variety of different forms coming from these general structures. The SM-PMSMs have permanent magnets placed on a surface of a rotor, where the permanent magnets are secured in position by either gluing them or wrapping an inert material around them. In IPMSMs, the permanent magnets are buried in the rotor back iron which provides mechanical protection to the permanent magnets.

In traction applications, one of the main requirements for an electric motor is to be capable of maintaining a wide constant power speed range (CPSR). Numerous ideas have been proposed to improve the efficiency of PMSMs such as enhanced excitation current control methodologies and a structural modification to the machine. Modifying the machine structure to improve the CPSR performance has been considered in a number of published research works.

Increasing saliency increases what is commonly known as saliency or reluctance torque, which contributes to the overall torque production in addition to the torque produced by the permanent magnet. One technique used to increase the saliency in an SM-PMSM is by using flux barriers. Another approach relies on tapering the machine's steel to create an asymmetry. Another approach to create an asymmetry for the purpose of enhancing the performance of a hybrid machine, with both a reluctance rotor and a permanent magnet rotor sharing the same shaft and stator, is by having the reluctance rotor axis shifted with respect to the permanent magnet rotor axis.

In view of the above, there are ongoing efforts to improve the efficiency of PMSMs, and it would be desirable if a PMSM was available that was capable of providing improved operational efficiency and reduced manufacturing cost.

Over the past few years, effort in the prior art has been expanded to develop a reluctance machine with high efficiency and high torque production capability relative to physical size. A reluctance machine is a type of magnetic device, e.g., a motor, where magnetic poles are induced in a rotating non-magnetic member (i.e., a rotor) by at least one winding in a stationary member (i.e., a stator). The rotor is typically provided with a plurality of salient (i.e., outwardly projecting) poles. The poles are induced by applying electrical current to the winding.

Exemplary prior art reluctance machines with distributed windings is depicted in FIG. 6. A cross-sectional view of a typical reluctance machine configuration with distributed windings is shown in FIG. 6. The reluctance machine 10 includes a stator assembly 12 and a rotor assembly 14. The stator assembly 12 includes a stator body 20 (also referred to as housing) with a plurality of stator teeth 22 coupled thereto. Windings (not shown) are provided around and about the stator teeth 22 in a distributed fashion. The rotor assembly 14 is centrally mounted within the stator assembly 12. The rotor assembly 14 includes a plurality of protruded poles 30 each having a pole face 32 that is substantially parallel with an interior surface defined by adjacent stator teeth 22. The rotor assembly 14 further includes a rotor core 26 and a shaft 24 centrally located about the rotor core 26. The reluctance machine 10 depicted in FIG. 6A includes a large number of stator teeth where many teeth are associated with a winding (not shown), and the associated phase. In the exemplary embodiment of the prior art depicted in FIG. 6A, the conventional reluctance machine may include three windings, each associated with a phase, where the windings are distributed around the teeth 22 (where a large number of teeth 22 are provided around the stator body). The rotor assembly 14, as depicted in FIG. 6A, includes four protruded poles 30, although it may include less or more poles.

Referring back to FIG. 6, it should be noted that flux characteristics of the air gap between the pole face 32 of each pole 30 and the adjacent stator teeth 22 remains substantially constant. The consistency in the flux characteristics results in the same torque output capability in either a clockwise 38 or a counter clockwise 36 rotational direction. In particular, as a leading edge 34b of a rotor pole 30 approaches the next stator tooth 22 when the rotor assembly 14 is rotating in the direction depicted by arrow 38 (i.e., clockwise directions), the output torque remains substantially the same as if a trailing edge 34a of a rotor pole 30 approaches the next stator tooth 22 when the rotor assembly 14 is rotating in the direction depicted by arrow 36 (i.e., counter clockwise) corresponding with a reversal of the rotational direction of the stator MMF.

Attempts to improve the performance of the synchronous reluctance machines are typically associated with design of the rotor assembly 14 of the reluctance machine 10 such that it will result in improved performance One category of performance is torque density which is the amount of torque that is generated relative to the physical size or mass of the machine for a given amount of loss. The rotor assembly 14 depicted in FIG. 6, although simple and can be manufactured at a relatively low cost, has relatively poor performance in terms of torque density, since flux density (i.e., the MMF resulting in output torque) varies considerably over the pole faces 32 of the pole 30, as discussed further below. Therefore the spatial region of high flux density is limited (which is a function of position within the rotor assembly 14), if a high degree of saturation (which leads to high loss) is to be avoided.

One approach to decrease power loss in one rotational direction is to employ an asymmetric reluctance machine (i.e., as compared to symmetric reluctance machines). Referring to FIG. 7 and as seen in U.S. Pat. No. 9,000,648 to Harianto et al., a cross sectional schematic view of a stator assembly 110 and a rotor assembly 140 of an asymmetric reluctance machine (ARM) 100 is depicted. The stator assembly 110 is a stationary member of the ARM 100 while the rotor assembly 140 is the portion of the A-RM 100 that moves (i.e., rotates about the stator assembly 110). The stator assembly 110 is cylindrical in shape including a housing 116 which transitions into a plurality of teeth 120 inwardly protruding toward center of the housing 116 along the radial direction. The teeth 120 are formed at intervals 130 along a circumferential direction.

The rotor assembly 140 includes a rotor core 150 and a plurality of outwardly protruding poles 160. Each of the plurality of outwardly protruding poles 160 has an asymmetrical shape, pointed out by the shape of pole tapers 164. The rotor assembly 140 also includes a shaft 170 positioned at the center of the rotor core 150.

The asymmetrical nature of the rotor assembly 140 improves the power loss of the reluctance machine in one direction (the main rotational direction of the reluctance machine). While this improvement is advantageous, additional improvement is needed.

Therefore, there is a need for a to power magnetic machine that improves output torque density based on the relationship between the rotor shape and the stator.

### SUMMARY

A permanent magnet machine is disclosed. The machine includes a stator assembly which includes a housing, a stator backiron, a plurality of windings disposed in the housing coupled to a plurality of electrical connections, and a plurality of stator teeth coupled to the stator backiron. The permanent magnet also includes a rotor assembly which includes a center configured to couple to a mechanical coupling member disposed about the center, an inner core, positioned around the center, an outer core disposed around the inner core, and a plurality of outwardly protruding poles radially located within the stator assembly each outwardly protruding pole having an outer surface adjacent to at least one tooth of the plurality of teeth. Each outer surface of each outwardly protruding pole having a rotor tooth extending from the outer core and a permanent magnet disposed next to the rotor tooth forming the outer surface that is substantially continuous.

A drive system is disclosed. The drive system includes a voltage source, and a permanent magnet machine as described above and structured to be coupled to a mechanical load.

### BRIEF DESCRIPTION OF DRAWINGS

FIG. 1 is a block diagram of a drive system including an a symmetrical permanent magnet synchronous machine (A-PMSM).

FIG. 2 is a cross sectional schematic view of the A-PMSM of FIG. 1, depicting a stator assembly and a rotor assembly, according to one embodiment of the present disclosure.

FIG. 3 is a close-up view of portions of the stator assembly and the rotor assembly of FIG. 2.

FIG. 4 is a graph of torque (measure in Nm) and power (measured in kW) vs. speed (measure in rpm).

FIG. 5 is a graph of weighted energy loss vs. cost for a typical surface mount permanent magnet synchronous machine (SM-PMSM) and an asymmetric permanent magnet synchronous machine (A-PMSM) of the present disclosure.

FIG. 6 is a cross sectional view schematic of a typical reluctance machine, according to one exemplary embodiment found in the prior art, depicting a reluctance machine with distributed windings (not shown) distributed about a stator assembly and further including a rotor assembly.

FIG. 7 is a cross sectional view schematic of a prior art asymmetric reluctance machine, with asymmetrical rotor blades.

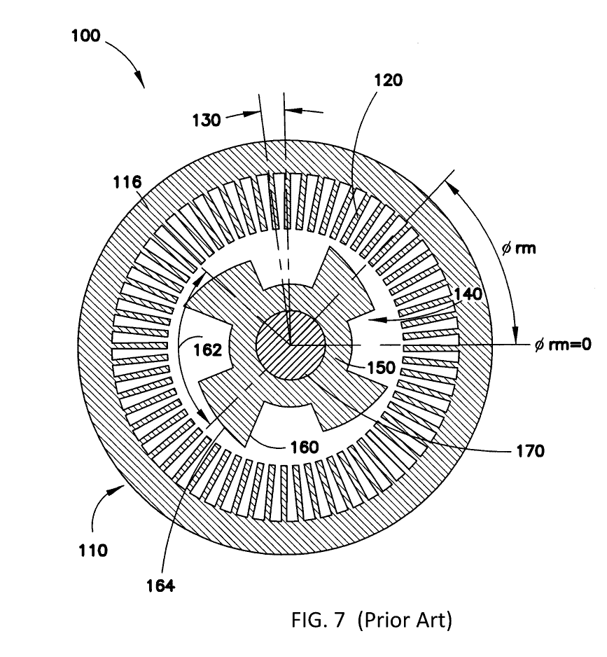

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A novel electric machine has been developed which improves torques output in one direction as compared to known prior art power magnet machines. In particular, aspects of the present disclosure provide an asymmetrical permanent magnet synchronous machine (A-PMSM) architecture that employs rotational asymmetry to reduce machine mass, cost, and power loss in constant power speed range (CPSR) applications.

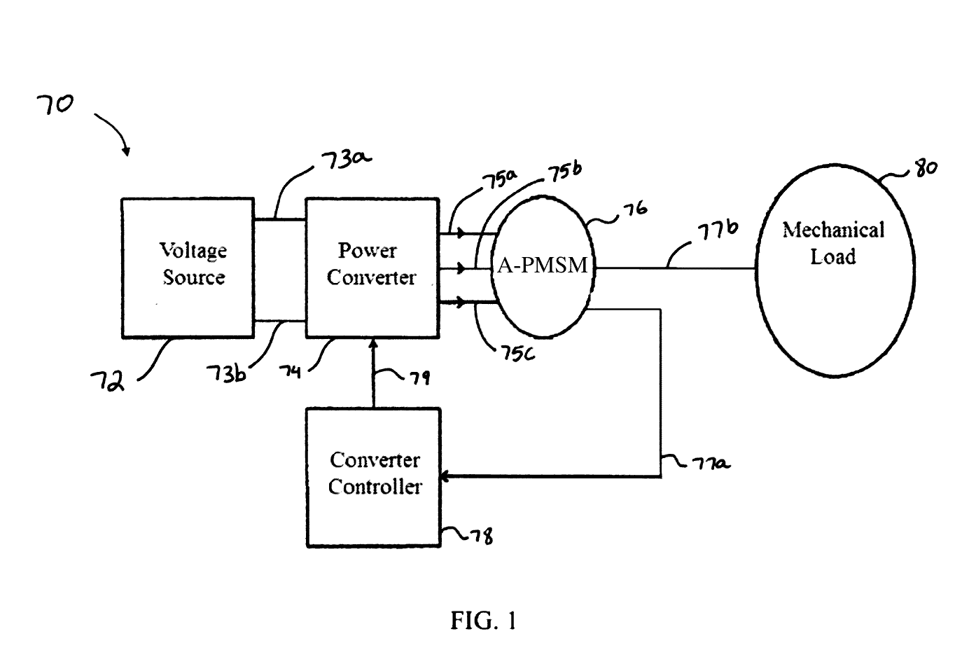

Referring to FIG. 1, a block diagram of a drive system 70 is depicted. The drive system 70 in an exemplary embodiment which includes a voltage source 72 and a power converter 74 coupled to the voltage source 72. The voltage source 72 is typically a single phase direct current (DC) source; however, single and multi-phase alternating current (AC) outputs are also possible. The voltage source 72 may represent power available at an electrical outlet. In such a configuration, an electrical conductor 73a represents a power output and an electrical conductor 73b represents a return (or commonly referred to as the neutral). Alternatively, the conductors 73a and 73b may represent conductors of a DC voltage source.

The power converter 74 includes power inputs which are connected to the conductors 73a and 73b to receive one of a DC power, a single-phase electrical current or a multi-phase electrical current (wherein, in a multi-phase AC configuration there are corresponding conductors). Additionally, the power converter 74 includes an input which is coupled to an output 79 of a converter controller 78, described further below. The Power converter 74 also includes three outputs representing three phases with currents that are each separated by 120 electrical degrees. Each phase is provided on a conductor 75a, 75b, and 75c. It should be noted that a common neutral line for return of each phase of the electrical currents is not shown and may or may not be present. It should also be appreciated that the power converter 74 may produce more or less number of phases (i.e., more or less than three phases).

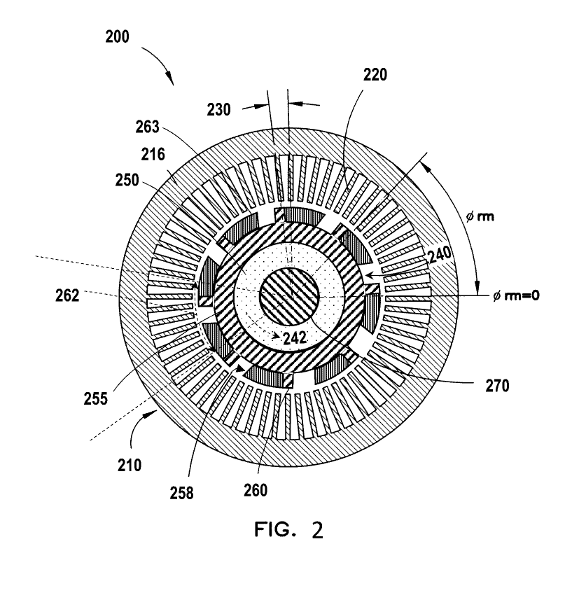

The drive system 70 also includes an A-PMSM 76 which is coupled to the power converter 74. The A-PMSM 76 may include a plurality of inputs which are connected to the conductors 75a, 75b, and 75c. The inputs are coupled to respective windings, described further below (see FIG. 2) which are distributed about a stator. The A-PMSM 76 includes a signal output 77a, which in one embodiment represents position of a rotor assembly 240 (see FIG. 2) with respect to a stator assembly 210 (see FIG. 2). The A-PMSM 76 also includes a mechanical output 77b which can be an interface for a mechanical coupling between the A-PMSM 76 and a mechanical load 80.

The drive system 70 also includes the converter controller 78 which is coupled to the A-PMSM 76 and the power converter 74. The converter controller 78 includes an input which is coupled to the signal output 77a of the A-PMSM 76. The signal output 77a represents a feedback signal from the A-PMSM 76 that can be used to control the power converter 74. In one embodiment, this feedback signal is the position of the rotor assembly 240 (see FIG. 2). In such an embodiment, the feedback signal (i.e., the signal output 77a) can be output of a variable reluctance (VR) sensor, an optical sensor, a hall-effect sensor, or other position determining sensors known to a person having ordinary skill in the art.

These sensors may be positioned on the rotor assembly 240 (see FIG. 2), on the stator assembly 210 (see FIG. 2), or positioned on both. Circuitry for conditioning the signal output 77a can be placed in the A-PMSM 76 or in the converter controller 78. Additionally, the converter controller 78 includes the output 79 which is coupled to the power converter 74. The output 79, therefore, represents the control signal from the converter controller 78 which is used to control the power converter 74. The combination of proper winding distribution and current waveform generate a desired stator magnetomotive force (MMF) distribution relative to the rotor assembly 240 (see FIG. 2).

It should be appreciated that in an alternative embodiment the power converter 74 may be avoided and the A-PMSM 76 powered directly by an appropriate voltage source 72.

It should also be appreciated that a synchronous reluctance machine is different than the A-PMSM 76, in that windings positioned in the rotor are short circuited to assist in startup (often referred to as damper windings). In such a configuration, the reluctance machine can be operated directly from a polyphase voltage source; thereby eliminating the need for power electronics or controls. However, the drive system 70 depicted in FIG. 1, includes the signal output 77a (i.e., control and rotor position feedback), thereby the aforementioned damper windings are not necessary. Addition of such a damper winding to the rotor of the A-PMSM 76, would have the advantage of being able to be operated without the power converter 74 or control scheme/electronics.

It should be appreciated that while the A-PMSM 76 of FIG. 1 is depicted as a reluctance machine that can receive electrical power to produce mechanical power, it can also be used such that it receives mechanical power and thereby converts that to electrical power. In such a configuration, the power converter 74 is utilized to excite the winding using a proper control and thereafter extract electrical power from the A-PMSM 76 while receiving mechanical power.

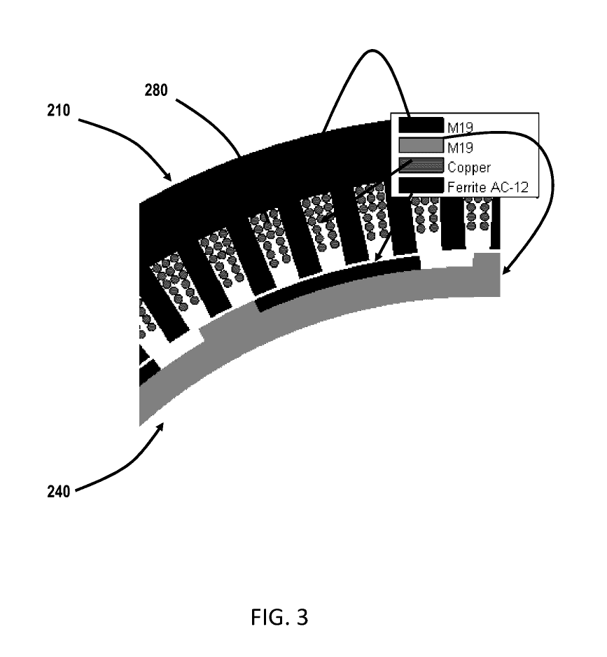

Referring to FIG. 2, a cross sectional schematic view of a stator assembly 210 and a rotor assembly 240 of an A-PMSM 200, according to one embodiment of the present disclosure is depicted. The stator assembly 210 is a stationary member of the A-PMSM 200 while the rotor assembly 240 is the portion of the A-PMSM 200 that moves (i.e., rotates about the stator assembly 210). The stator assembly 210 is cylindrical in shape including a a housing (not shown), a stator backiron 216 which transitions into a plurality of teeth 220 inwardly protruding toward center of the stator backiron 216 along the radial direction. The teeth 220 are formed at intervals 230 along a circumferential direction. The number of teeth 220, which is a function of the intervals 230, is a design parameter that can affect torque ripple and other electrical and mechanical characteristics of the A-PMSM 200 as is known to a person having ordinary skill in the art. The stator assembly 210 is configured to have a single or multi-phase distributed winding (see FIG. 3) and corresponding electrical connections (not shown) that can be placed about the stator teeth 220.

The rotor assembly 240 includes an inner core 250 which could be made from a magnetically inert material and an outer core 255 which terminates in a plurality of outwardly protruding poles 258 (which can also be made from magnetic steel). Each of the plurality of outwardly protruding poles 258 forms an asymmetric arrangement, pointed out by a rotor tooth 260 and a permanent magnet 263. The permanent magnets can be made from ferrite, samariam cobolt, neodynium iron boron, or other magnetic material known to a person having ordinary skill in the art. The rotor assembly 240 also includes a center configured to receive a shaft 270 (or also referred to as a mechanical coupling member) positioned at the center of the inner core 250. The shaft 270 is configured to be coupled to a mechanical load (e.g., the mechanical load 80 depicted in FIG. 1). The outwardly protruding poles 258 are formed at intervals 262 along a circumferential direction. The number of outwardly protruding poles 258, which is a function of the intervals 262, is a design parameter that can affect torque ripple and other electrical and mechanical characteristics of the A-PMSM 200 as is known to a person having ordinary skill in the art.

The ratio of circumferential portions defined by the rotor tooth and the accompanying permanent magnet 263 define the asymmetrical nature of the A-PMSM.

While a curved surface is depicted in FIG. 2 for the rotor tooth 260 and magnet 263, other possible surfaces can be realized with the goal being to maximize flux density substantially over the entire the outward protruding pole 258. The asymmetry between these pole (i.e., the rotor tooth 260 and the permanent magnet 263) on the outer surface of the outwardly protruding poles 258 is such that the flux density profile can be manipulated as the operating point is changed to yield improved performance. The maximum allowed flux density is defined by an amount of flux that saturates the material of the outwardly protruding poles 258 or corresponding stator teeth based on its shape. Therefore, the asymmetry depicted in FIG. 2 is influenced by shapes and configuration of the stator assembly 210 and the rotor assembly 240. Other asymmetrical arrangements may result in differing flux density profiles.

It should be appreciated that it is the flux density profile on the stator teeth 220 over the outwardly protruding poles 258 that define the pole asymmetry. It should be noted that the flux density in the stator teeth 220 and the outwardly protruding poles 258 are correlated. However, the flux density in the stator teeth 220 becomes higher as the teeth conduct the flux over the slots between the teeth 220.

One goal is to cause the flux profile of the stator teeth 220 that are over the outwardly protruding poles 258 to be such as to be favorable from torque production and loss viewpoints, particular as operating conditions (speed, required torque) change.

Additionally, the shape of the rotor assembly 240 and in particular the shape and characteristics of the asymmetry defined by the rotor tooth 260 and permanent magnet 263 of the outwardly protruding poles 258 in relationship to the stator assembly 210 and in particular to its teeth 220, results in a flux density profile over the surface of the outwardly protruding poles 258 and in particular over the outer surfaces of the rotor tooth 260 and the permanent magnet 263 so as to be favorable from a torque production and loss viewpoints.

Therefore, the asymmetry is designed 1) to generate a flux density profile over the poles (i.e., the outer surfaces of the rotor tooth 260 and the permanent magnet 263) of the outwardly protruding poles 258 which is favorable for torque production; and 2) to have this profile be adjustable with operating conditions so as to facilitate a wide speed range.

Referring to FIG. 3, a close-up of portions of the stator assembly 210 and the rotor assembly 240 is provided. The stator assembly 210 includes a single or multi-phase distributed winding 280 shown between the stator teeth 220.

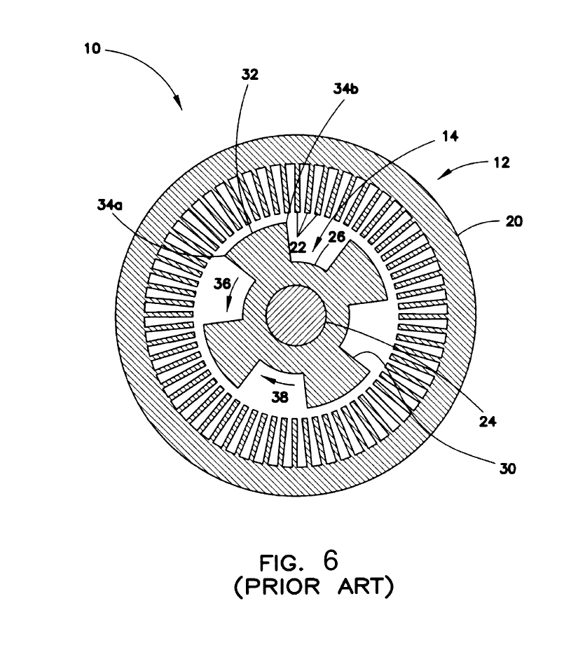

It should be observed that the rotor shape of a conventional PMSM substantially achieves the same flux density over the poles irrespective of the direction of the desired torque. Thus, the induced field is substantially the same with the rotor assembly 14 rotating in the direction of arrow 36 or 38 (see FIG. 6).

In comparison, the rotor assembly 240 (see FIG. 2) of the present disclosure provides a novel rotor designed to induce a tailored field in the outwardly protruding poles 258 over the surfaces of 164 when the rotor is rotating in one direction (e.g., designated by the arrow 242).

Since a higher amount of output torque is produced, the A-PMSM of the present disclosure can be smaller, lighter, and less costly as compared to a conventional PMSM producing the same output torque. In contrast, for the same size PMSM, the A-PMSM of the present disclosure can generate a higher level of output torque in one direction (e.g., direction 142b as shown in FIG. 2), which is an acceptable limitation in many applications where the output torque needs to be high only in one principal direction. In addition, due to the uniformity of the induced field, the A-PMSM of the present disclosure produces smaller amounts of ripple in the output torque.

Lower torque ripple can result in a smoother operation of the A-PMSM even in lower speeds.

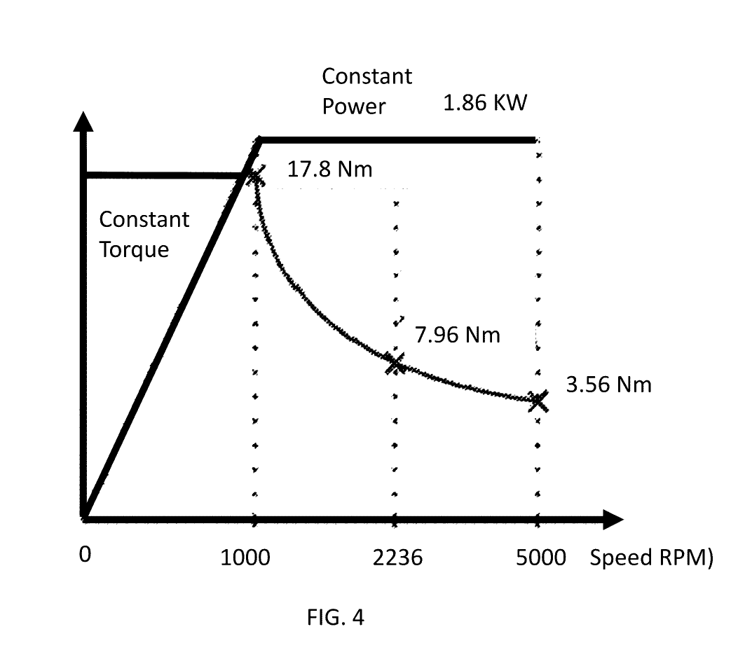

Referring to FIG. 4, a graph of torque and power vs. RPM is provided for the A-PMSM of the present disclosure. The torque graph is divided into a substantially constant portion (17.8 Nm according to one embodiment) followed by a drop in the torque. The power graph is also divided into two corresponding portions wherein the first corresponding portion output power increases from zero to a maximum (e.g., to about 1.86 KW) corresponding to a substantially constant torque and then remains substantially constant at that maximum as corresponding to the declining toque.

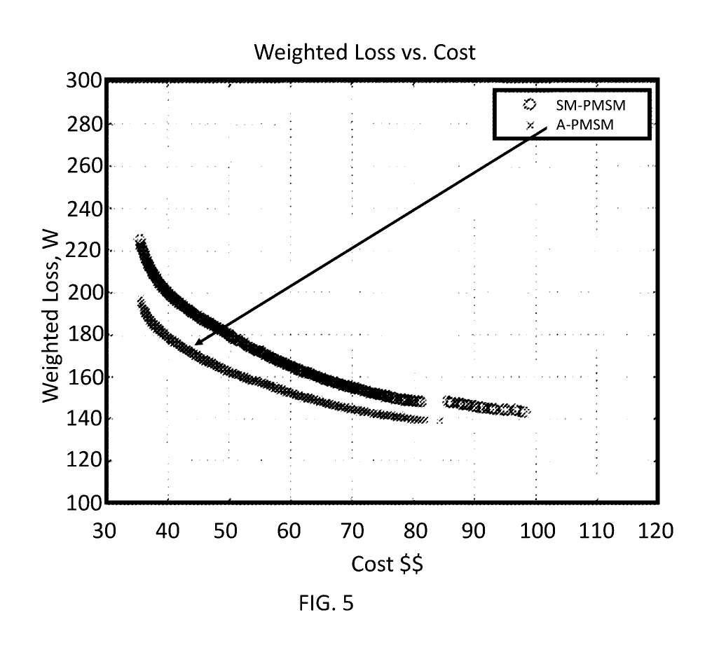

Referring to FIG. 5 a weighted energy loss (measured in Watts) vs. cost (measured in $$) is provided to compare a conventional surface mount PMSM with an A-PMSM of the present disclosure. As can be seen the energy loss is lower for the A-PMSM of the present disclosure providing a showing that arrangement of the present disclosure provides an advantage over the conventional PMSM. Note that for the same weighted power loss, the A-PMSM of the present disclosure can provide a total cost reduction of around 18% compared to the SM-PMSM. This improvement is important in applications that use PMSM equipped with expensive rare-earth permanent magnets, and that are unidirectional, such as traction and spindle drive applications.

In operation, with respect to FIG. 1, electrical power can be provided from the voltage source 72 in DC, single-phase AC, or polyphase AC form. The electrical power can then be optionally converted to a three-phase output by the power converter 74 and provided to the A-PMSM 76. The A-PMSM 76 in this configuration is configured to receive electrical power and convert it to mechanical power to thereby apply the mechanical power to the mechanical load 80. A position signal can be placed on the signal output 77a and provided to converter controller 78 to control the power converter 74.

Alternatively, the A-PMSM 76 can be configured to convert mechanical power to electrical power. In this configuration, the mechanical load 80 is providing mechanical power to the A-PMSM 76 and in turn, the A-PMSM 76 converts the mechanical power to electrical power which is provided to the power converter 74 or directly to the voltage source 72.

While the asymmetrical rotor concept described here has been applied to a permanent magnet machine, it is recognized that the same concept could be applied to other types of machines which use a continuously rotating magnetic field, wherein the rotor rotates in synchronism with the field, including wound rotor synchronous machines.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A permanent magnet machine, comprising:
a stator assembly including
a housing,
a stator backiron,
a plurality of windings disposed in the housing coupled to a plurality of electrical connections, and
a plurality of stator teeth coupled to the stator backiron;
a rotor assembly including
a center configured to couple to a mechanical coupling member disposed about the center,
an inner core disposed around the center,
an outer core disposed around the inner core, and
a plurality of outwardly protruding poles radially located within the stator assembly each outwardly protruding pole having an outer surface adjacent to at least one tooth of the plurality of teeth;
wherein each outer surface of each outwardly protruding pole having a rotor tooth extending from the outer core and a permanent magnet disposed next to the rotor tooth.

2. The permanent magnet machine of claim 1, wherein upon applying a plurality of electrical currents in a first form, each to a corresponding electrical connection of the plurality of electrical connections, the rotor assembly produces a first torque output in a first rotational direction and upon applying a plurality of currents in a second form, each to a corresponding electrical connection of the plurality of electrical connections, the rotor assembly produces a second torque output in a second opposite rotational direction, wherein the magnitude of each current of the plurality of electrical currents in the first form is substantially equal to a corresponding current of the plurality of electrical currents in the second form.

3. The permanent magnet machine of claim 2, wherein magnitude of the first torque output is higher than magnitude of the second torque output.

4. The permanent magnet machine of claim 1, wherein the plurality of windings are distributed about the housing.

5. The permanent magnet machine of claim 1, wherein each of the windings of the plurality of windings is configured to be coupled to an electrical current having a corresponding phase coupled to a corresponding electrical connection.

6. The permanent magnet machine of claim 5, wherein the plurality of windings are distributed about the stator teeth.

7. The permanent magnet machine of claim 1, wherein the rotor tooth of each outwardly protruding pole is equidistant away from the center and the permanent magnet of each outwardly protruding pole is equidistant away from the center.

8. The permanent magnet machine of claim 1, wherein upon applying a plurality of electrical currents, each to a corresponding winding of the plurality of windings, magnetic field induced in each of the outwardly protruding poles is substantially uniformly distributed over the outer surface of each of the outwardly protruding poles.

9. The permanent magnet machine of claim 1, the permanent magnet is constructed from ferrite, samariam cobolt, neodymium iron boron, or a combination thereof.

10. A drive system, comprising: a voltage source; and
a permanent magnet machine configured to be coupled to a mechanical load, the permanent magnet machine including
a stator assembly including
a housing,
a stator backiron
a plurality of windings disposed in the housing coupled to a plurality of electrical connections, and
a plurality of stator teeth coupled to the stator backiron;
a rotor assembly including
a center configured to couple to a mechanical coupling member disposed about the center,
an inner core disposed around the center,
an outer core disposed around the inner core, and
a plurality of outwardly protruding poles radially located within the stator assembly each outwardly protruding pole having an outer surface adjacent to at least one tooth of the plurality of teeth;
wherein each outer surface of each outwardly protruding pole having a rotor tooth extending from the outer core and a permanent magnet disposed next to the rotor tooth forming the outer surface.

11. The drive system of claim 10, wherein the plurality of electrical connections are coupled to the voltage source.

12. The drive system of claim 10, further comprising:
a power converter configured to i) receive electrical power from the voltage source in a first form and provide electrical power to the permanent magnet machine in a second form; and ii) receive electrical power from the permanent magnet machine in the second form and provide electrical power to the voltage source in the first form,
wherein the electrical power in the first form is an electrical current having an initial phase, and the electrical power in the second form includes a plurality of electrical currents each having a corresponding phase and coupled to a corresponding electrical connection of the plurality of electrical connections, and
wherein each of the windings of the plurality of windings is configured to be coupled to a corresponding electrical current of the plurality of electrical currents.

13. The drive system of claim 10, wherein upon applying a plurality of electrical currents in a first form, each to a corresponding electrical connection of the plurality of electrical connections, the rotor assembly produces a first torque output in a first rotational direction and upon applying a plurality of currents in a second form, each to a corresponding electrical connection of the plurality of electrical connections, the rotor assembly produces a second torque output in a second opposite rotational direction, wherein the magnitude of each current of the plurality of electrical currents in the first form is substantially equal to a corresponding current of the plurality of electrical currents in the second form.

14. The drive system of claim 13, wherein magnitude of the first torque output is higher than magnitude of the second torque output.

15. The drive system of claim 10, wherein the rotor tooth of each outwardly protruding pole is equidistant away from the center and the permanent magnet of each outwardly protruding pole is equidistant away from the center.

16. The permanent magnet machine of claim 1, wherein upon applying a plurality of electrical currents, each to a corresponding winding of the plurality of windings, magnetic field induced in each of the outwardly protruding poles is selectively chosen over the outer surface of each of the outwardly protruding poles.

17. The drive system of claim 10, the permanent magnet machine of claim 1, the permanent magnet is constructed from ferrite, samariam cobolt, neodymium iron boron, or a combination thereof.

18. The drive system of claim 12, further comprising:
a position sensor configured to sense position of the rotor assembly with respect to the stator assembly and generate an electrical position signal in response thereto; and
a converter controller coupled to the permanent magnet machine and to the power converter, wherein the converter controller is configured to receive the electrical position signal, and provide a control signal to the power converter to thereby control output power to the permanent magnet machine in the second form.

19. The drive system of claim 18, wherein the power converter is configured to control output power to the permanent magnet machine in the second form by controlling current waveforms.

20. The drive system of claim 10, wherein the permanent magnet machine is configured to i) receive electrical power and convert the electrical power to mechanical power, and ii) receive mechanical power and convert the mechanical power to electrical power.
